(19) United States
(12) Patent Application Publication
(10) Pub. No.: US 2010/0305992 A1
(43) Pub. Date: Dec. 2, 2010

(54) SYSTEM AND METHOD OF ELECTRONIC INVESTIGATION MANAGEMENT

(75) Inventors: Kenneth T. Michalzuk, Rosslyn, VA (US); Danilo F. Fularon, Rosslyn, VA (US); Rhonda L. Cheatham, Washington, DC (US); Dzung M. Ta, Rosslyn, VA (US); Iris Chang, Rosslyn, CA (US); Terry Heismann, Orlando, FL (US); Steven D. Nguyen, Rosslyn, VA (US); James T. Taylor, Rosslyn, VA (US); Patricia Manzolillo, Dulles, VA (US)

Correspondence Address: KNOBBE MARTENS OLSON & BEAR LLP, 2040 MAIN STREET, FOURTEENTH FLOOR, IRVINE, CA, 92614, US

(73) Assignee: United States Postal Services, Washington, DC (US)

(21) Appl. No.: 12/475,365

(22) Filed: May 29, 2009

(51) Int. Cl. G06Q 10/00

(52) U.S. Cl. 705/7; 705/28

(57) ABSTRACT

Systems and methods to manage and mechanize investigations and associated evidence gathering, documentation and retention. Methods for using barcodes for processing and storing evidence in an investigation are provided.

### BACKGROUND

1. Field

This embodiment relates to an electronic system for managing and automating management of investigations and associated evidence gathering, documentation, and retention.

2. Description of the Related Technology

Manual and paper-based methods of managing investigations and tracking investigation-related resources may have inadequate control and visibility for case investigators over the case files and also require a large amount of manual and error-prone data entering. Moreover, such systems can be very costly in terms of money, storage space and paper management. Proper maintenance of chain-of-custody data on evidence collected during an investigation may be a requirement of using the evidence in a legal proceeding. However, with a manual/paper system, evidence collected at a scene may not be logged into a case management system or otherwise marked until the investigator returns to an office location. This often results in unreliable tracking of stored evidence or unreliable documentation of the final disposition of evidence after the case is closed or transferred. In many cases, these manual or paper-based methods do not support sharing evidence information among cases or transferring evidence information between cases.

### SUMMARY OF CERTAIN INVENTIVE ASPECTS

The system and method of the development each have several aspects, no single one of which is solely responsible for its desirable attributes. Without limiting the scope of this development as expressed by the claims which follow, its more prominent features will now be discussed briefly. After considering this discussion, and particularly after reading the section entitled “Detailed Description of Certain Embodiments” one will understand how the features of this development provide advantages that include electronic management and monitoring of evidence.

One embodiment comprises an electronic laboratory crime lab management system, the system comprising a memory configured to store data associated with laboratory requests and data indicative of utilization of laboratory resources; and a processor configured to receive at least one electronic request for a laboratory examination of an item submitted to a lab, store data indicative of the at least one received request to the memory; receive actions associated with processing the at least one laboratory request; and track and store information indicative of laboratory work performed on and associated with the item submitted to the crime lab starting with the request and continuing through an investigation and closure of the case, based on the received processing actions.

Another embodiment comprises an automated system for electronic management and tracking of evidence. This embodiment is utilizes a computing environment having a processor and a data storage. The evidence system comprises a memory configured to store at least evidence collection data and evidence tracking profiles, and store data associating the evidence collection data with a scene of an investigation. The system also comprises at least one processor configured to: detect a data connection with a mobile scanner configured to scan data indicative of evidence at the scene of an investigation, receive information from the mobile scanner, receive data indicative of the assignment of the evidence and its associated information to an investigation, and track evidence inventory and information via data received for each item of evidence or evidence packaging.

Another embodiment comprises an automated inspection service information system for use in a computing environment having a processor and a data storage. The system comprises a memory configured to store data indicative of employee and user profiles, store activities indicative of an investigation, and store available resources for a specific task assignment. The system also comprises at least one processor configured to electronically process and track evidence, and monitor activities associated with criminal investigations, provide electronic requests for laboratory examination to a crime lab, and manage and monitor data indicative of a crime investigation. The data is associated with employee training and employee skills, applications for detail assignments, results of employee searches, and reviewed employee objectives; and monitor available resources for a specific task assignment and determine where the resources within that task assignment should be located. The system provides, based on the information stored in a memory and processed by the system, the data indicative of the resources for assignment to certain investigations.

Yet another embodiment comprises a method for tracking evidence, the method comprising receiving into a server, via an electronic reader device, data indicative of an identifier relating to a piece of evidence; storing the data to a database; associating the identifier with case; maintaining a database having entries indicative of processing steps associated with the item of evidence; providing system users the ability to electronically manage resources and track data related to a case and querying a database having records indicative of actions associated with the database, and displaying data indicative of at least one record of the database.

### BRIEF DESCRIPTION OF THE DRAWINGS

FIG. 1 is a block diagram of an embodiment of an inspection service application program.

FIG. 2A is a screen shot illustrating an embodiment of a User's Home Page of the inspection service application program.

FIG. 2B is a screen shot illustrating an embodiment of a Case Management Screen of the inspection service application program.

FIG. 2C is a screen shot illustrating an embodiment of a Cases Menu Page of the inspection service application program.

FIG. 2D is a screen shot illustrating an embodiment of a Subjects, Case Reports and Logs Page of the inspection service application program.

FIG. 3A illustrates an embodiment of a Property Evidence Application Program (PEAP) Process Flow of the inspection service application program.

FIG. 3B is a screen shot illustrating an embodiment of a PEAP page of the inspection service application program.

FIG. 3C is a screen shot illustrating another embodiment of a PEAP Working With Evidence Page of the inspection service application program.

FIG. 4 is a screen shot illustrating an embodiment of a Laboratory Information Management System (LIMS) Submission Page of the inspection service application program.

### DETAILED DESCRIPTION OF THE PREFERRED EMBODIMENT

The following detailed description is directed to certain specific embodiments of the development. However, the development can be embodied in a multitude of different ways as defined and covered by the claims. In this description, reference is made to the drawings wherein like parts are designated with like numerals throughout.

One embodiment is provided in the context of the United State Postal Inspection Service (USPIS). However, the USPIS embodiment is just one embodiment and is used in this specification for continuity of explanation. It is to be recognized that other embodiments may be configured for use in any organization with investigative or evidence tracking activities or functions.

The embodiments can increase the efficiency of management and tracking processes in an investigation by enabling electronic completion and submission of data and specific forms for higher level review, reporting, and approval. For example, electronic applications may replace hard copy forms and hand-signed approvals. Also, embodiments may be configured to provide system users (based on access rights) with user interfaces to enter data directly into the system, reducing the need for a specialized skilled support staff

In one embodiment, electronic files can be attached to cases, and certain processes reduce or eliminate the need for physical case files. In one embodiment, users may run customized reports to assist users in maintaining their open investigations and other data related to a case or to the user himself Management may run reports to manage records and help determine adequate levels of staffing.

Some embodiments may include a system that comprises an Enterprise Architecture and Service Oriented Architecture (SOA) solution and is a nationally integrated database system providing a broad range of investigative and management information to all installations. The use of multiple inter-related applications can provide for the rapid entry of retrieval of data. This makes the embodiment an effective tool to ensure proper procedures are followed, all property is accounted for and high-risk program aids, such as electronic surveillance, can be monitored thoroughly and efficiently.

One embodiment includes numerous subsystems all of which are interrelated. For example, one embodiment includes access control, e.g., in the illustrated embodiment, access can be limited to USPIS employees and others authorized due to their relationship with the organization. For example, access is granted based on an individual's proprietary logon and password. Data is protected by controlling access, logon actions and reporting exceptions. Desirably, embodiments can provide users (e.g., investigative or lab personnel) access only the parts of the system necessary for them to perform their duties. Personnel entering data are trained in the respective areas for which they are responsible. In one embodiment, internal safeguards exist to help preserve the integrity and completeness of the data.

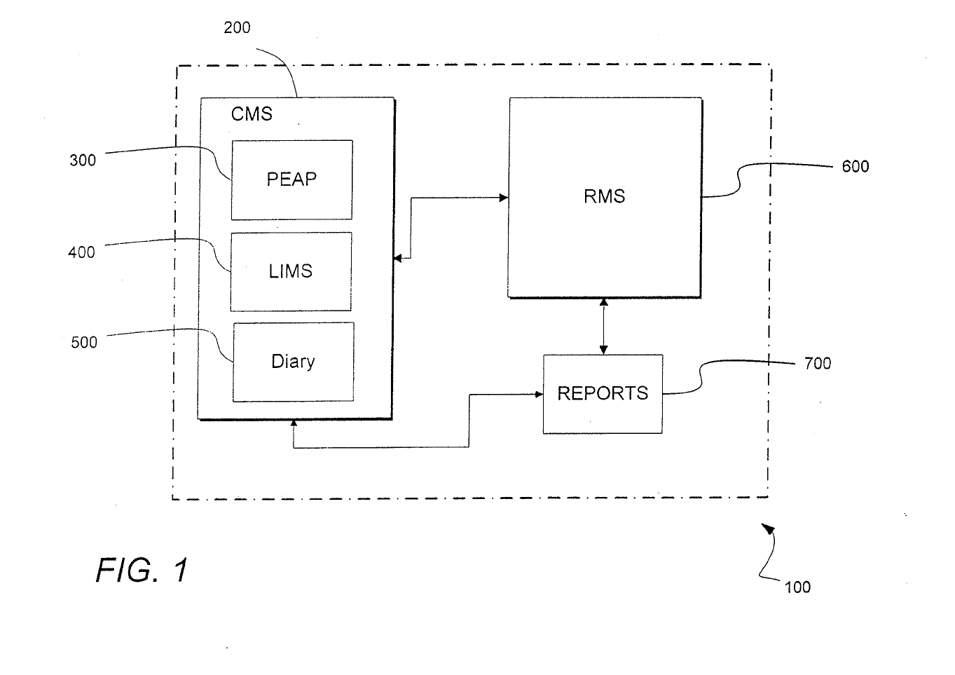

FIG. 1 illustrates a block diagram depicting an embodiment of the system 100. In particular, the system 100 includes a Case Management System (CMS) module 200 and a Resource Management System (RMS) module 600. In the illustrated embodiment, the CMS module 200 further comprises a Property Evidence Application Program (PEAP) 300, a Laboratory Information Management System (LIMS) module 400, and an electronic Diary 500. In the illustrated embodiment, the system 100 further comprises a Reports module 700. In one embodiment, the system 100 is adapted for use with the US Postal Service in its investigation unit, Inspection Service Integrated Information System (ISIIS). For purposes of illustration, the system 100 is discussed with reference to this embodiment.

The CMS module 200 comprises an integrated, online database system designed to document and track investigative activities for all levels of an organization. In one embodiment, all case details are entered and retrieved online. Data entry, selection, and retrieval options can be configured to be flexible to allow entries to meet specific case requirement and internal organization policies. Additional criteria, options or prompts are provided when further action or the information is required as a result of an action, or series of actions performed in the system 100. Certain desirable features and sub-systems of the CMS system 200 are further explained below. It is to be recognized that various embodiments may optionally include only some, or all, of such features and sub-systems.

The PEAP 300 system module provides a streamlined electronic process of evidence collection and tracking procedure. For example, the PEAP system 300 uses preprinted barcode labels that are assigned to every piece of evidence as the basis of tracking evidence inventory and information. In one embodiment, each piece of evidence's preprinted barcode label is scanned by a mobile hand-held scanner at the crime scene. Data indicative of the evidence collected at a crime scene is stored in the mobile hand held scanner and then uploaded to the PEAP 300 system by connecting the scanner to a docking station or other device that is further connected to the PEAP 300 via a data network. In other embodiments, the handheld scanner connects wirelessly, e.g., via a data network or via infrared connection. In other embodiments, the scanner has a removable memory that can then be transferred to the computer. In other embodiments, the handheld scanner is replaced by a handheld or mobile computer, such as a pda or smartphone with barcode reading functions (e.g., via a dedicated barcode reader or via a camera integrated with or in communication with the handheld computer).

Once a piece of evidence's barcode level is uploaded into the PEAP 300 system module, the user may enter detailed information about evidence by accessing the records associated with the evidence via records associated with the bar-coded label. In this embodiment, the PEAP 300 module uses a database to store evidence barcodes, information, current inventory location, chain of custody, and responsible party history. Authorized personnel can use the PEAP system 300 to track evidence in a more detailed manner than the current methods. The detailed information about the evidence may include data associating the evidence with a particular case or investigation. In some embodiments, the handheld scanner record may include additional information about the evidence item, such as its GPS coordinates at the time of scan, the actual time of the scan, or other location data.

The LIMS 400 module enables users of the system 100 to submit an electronic request for laboratory examination to the crime lab, for instance, the USPIS crime lab. The lab request and lab results may be stored as part of the electronic case management system 100. In some embodiments, numerous reports are designed to provide a lab or investigative service with ways to monitor and track laboratory requests, the specific type of lab work requested, and which lab personnel are assigned specific tasks.

A sub-system of the CMS 200, is the electronic Diary 500. The Diary 500 of the system 100 provides an organization's employees an interface through which to enter and submit activities and hours being charged directly against a case, as well as time associated with other employee activities, including leave, administrative time, and training. The Diary 500 maintains stored data indicative of actual time spent on specific cases or other activities and, based on data entered or submitted, provides tracking and retrieval functions for users as may be requested.

Users of the electronic Diary 500 can submit information about their work and skills into the system 100. For instance, employees can submit work hours in to the system 100 on a regular basis, for instance a daily basis. Work hours entered in the system 100 each day are rolled up into various work hour reports on a regular basis, for instance, a weekly basis. In one embodiment, each employee electronically submits a diary report which is stored by a Diary 500 on a monthly basis to his manager for viewing and approval. In one embodiment, the data integrity of the Diary 500 is maintained by requiring approvals for altering previously submitted reports. System 100 reports can thereby be configured to provide a tool to assist management in determining the amount of resources a specific job assignment should have and where the resources within that job assignment should be located.

The RMS 600 module is an online database of human resource information that pertains to each organization employee. RMS 600, in one embodiment, is configured to electronically integrate with some or all of the other applications of the system 100. Within a database of the RMS module 600, employees are assigned to divisions and specific managers or teams. In one embodiment, the RMS 600 module is configured to provide employees an interface to access various components such as components which enable them to name their own profiles, track training and other skills, apply for detail assignments, conduct employee searches, and complete the required objectives mid-year and year-end reviews or performance steps for certain employment positions, for example, within the organization (e.g., USPIS, the Inspection Service Law Enforcement (ISLE) or Inspection Service Executive Series (ISES).

In one embodiment, the RMS 600 provides a tool to manage personnel resources. For example, the RMS module 600 comprises menu choices or options such as the use of the Securing Clearance Tracking System (SCTS), which provides an interface to document employee security clearances and track clearances soon to expire. The embodiment may also include other modules or options, for instance, a Complement Module which shows management the current authorized complement of any division, along with the specific job openings if the division is under their authorized complement. The Health Assessment Module tracks the history of all necessary medical tests that are completed, or are scheduled based on an employee's position and age. This embodiment includes an Other Reports module which generates reports based on an employee's entered on-duty date, occupation code and specific assignment. The report will output additional information such as an employee separation report, seniority lists, active inspector lists, etc.

In one embodiment, the RMS application 600 within the system 100 is an integrated computer system, centralizing and tracking personnel information for the organization. The RMS module 600 is accessed, for example, by clicking a link under the system heading on the home page or any other suitable location. Access to various RMS functions (for instance, tabs and menus) depends on the user's job title and responsibilities.

In this embodiment, employees of an organization populate RMS 600 as a result of a form or other suitable information output medium as defined by the organization. The associated information is uploaded into RMS after the employee has been granted a requisite interim security clearance. The RMS 600 provides access for a coordinator of a particular group or division to choose a new employee from a list of division employees and assign him or her to a specific position, job, or team within his or her division. In other embodiments, any field may be linked to other suitable fields so as to pre-populate a set of choices to present to the user.

In one embodiment, all applications access the employee record (information) in RMS 600 to determine the flow of a specific request when any type of higher level review or approval is necessary. For instance, when jacketing a case or investigation, the Jacket New Case screen will be completed, then based on RMS 600 information, is sent to the case owner's manager for approval. After approval, required information, for instance, the division number, team number, etc., is auto-populated based on the existing RMS employee information. One skilled in the art will appreciate that there are countless ways to gather and validate the information and to auto populate fields where appropriate.

The RMS 600 system may display a default or opening screen. This screen may be displayed after a user selects a tab or button indicative of the RMS 600 module. In one embodiment, several tab options are available to the user, for instance, one tab may contain detailed information about each job in an organization. If selected, this tab produces a “Standard Position Job Description” for viewing and printing by the user. A subsection of the jobs module is configured to include detail positions.

In one embodiment, general users can select and view any job assignment or detail posting. They can also submit or nominate themselves for a specific detail position. User accounts with a certain status or attribute, for instance an Administrator or other similar team or division leader status, can create posts and fill jobs and detail assignments. For instance, in these embodiments, human resources users are able to modify, create, deactivate and reactivate job listings. They can also modify the authorized complement of any division. In this embodiment, the RMS 600 comprises an Employee module which stores information concerning personnel. The RMS 600 module collects, for instance, name, contact information, division, domicile, team, and/or manager information. The RMS system 600 can be configured to provide user interfaces that “general” users are able to view and which allows those users to modify their basic information, add skills, and make electronic Requests. Users are also able to verify that certifications and Vehicle Drive Home requests, as well as other paperwork, are submitted and approved electronically. “Human Resources” users can search and edit employee information, approve the addition of skills and collateral duties, re-assign direct reports, delegate authority, and separate or reinstate employees.

In one embodiment, a Training module tab provides a user interface displaying training related records such as course descriptions, course scheduling, course enrollments, and supplies this information to an employee's record. The system 100 provides access to general users to search for course descriptions or enrollment details within a course, request creation of new non-catalog courses, view all courses, add a new course schedule, and enroll in a course. Administrative users can enroll a group into a course, view and approve/deny all pending course requests, record attendance of employees at scheduled sessions, and search employee training data. In one embodiment, only certain users can create or modify a course.

In one embodiment, an Organization tab provides the specific organizational information for a division, its domiciles, and teams. The system 100 provides access to general users to view information pertaining to any division, domicile, and/or team. Division Administrators can modify and create teams within their own division. Users with certain privileges can further modify this information and add new divisions, domiciles and teams. These new organizational areas are then available within RMS for authorized positions, job assignments, sponsoring training, etc.

In one embodiment, a Security Clearance Tracking System (SCTS) module tab of RMS provides access to all security clearance requests and their status. Access to certain Security functions is only available to certain personnel as granted by the organization.

In one embodiment, a Health Assessment module tab of the RMS governs tracking of inspectors' health examination schedules and tracking of procedures. The system 100 provides general users the interface to view their own exam information (including ratings), verify the status of procedures and exam schedules, and update medical information. HR administrators are able to view any employee exam and procedure follow-up information, certify invoices for procedures, and export/import health records to government health agencies such as CHS.

In one embodiment, a Maintenance tab is provided to specific employees that have been approved by their manager. The Maintenance tab also controls the contents of many of the drop-down selectors used to choose items from the lists in RMS 600. The system 100 provides an interface for users to add a new entry or edit an entry in various areas. This tab is available to HR and others involved in training as well as any other approved department.

In one embodiment, a Reports module of RMS generates statistical and canned reports. The system 100 provides general users access any RMS report that is available to them, availability which is dependent on the user's job assignment. Available RMS reports relate to the various features including Jobs, employees, Health, Assessment, SCTS, Training, and Organization.

Another feature of the RMS system 600 provides all non-organizational employees (including executives) the ability to submit their goals, objectives, and accomplishments. Evaluators comment, approve, and return these objectives and accomplishments throughout the performance review cycle.

In one embodiment, the RMS 600 system provides a display indicative of further information about employees. In this embodiment, a Display Employee page will open after the Employee tab from the top menu bar is selected. All users can: View and modify their own personal data (home address, phone info emergency contact info, etc.), and View their own accountable property.

In one embodiment, Human Resources users can: View another employee's accountable property, modify and update other employee information, separate and reinstate employees, search employees based on any one of a number of criteria (in some embodiments is available to all users), re-assign direct reports from one manager to another manager, approve employee collateral duties to an employee's record, approve the addition of employee skills to an employee's record, and delegate authority by selecting another employee to act on their behalf (the delegate will receive notifications for actions that would normally go to that manager).

In one embodiment, the system 100 will accept electronic requests. The system 100 provides a Search Requests option, and also a predefined list of electronic requests as defined by the organization.

Finally, all case statistics are rolled up into the various system 100 Reports 700 on a weekly basis. The system 100 can be configured to require that changes to approved statistics be re-approved by the employee's manager. All statistics are “frozen” for ten days following the end of the fiscal year or some other end of an accounting or balancing period. This information provides the basis for reports to others.

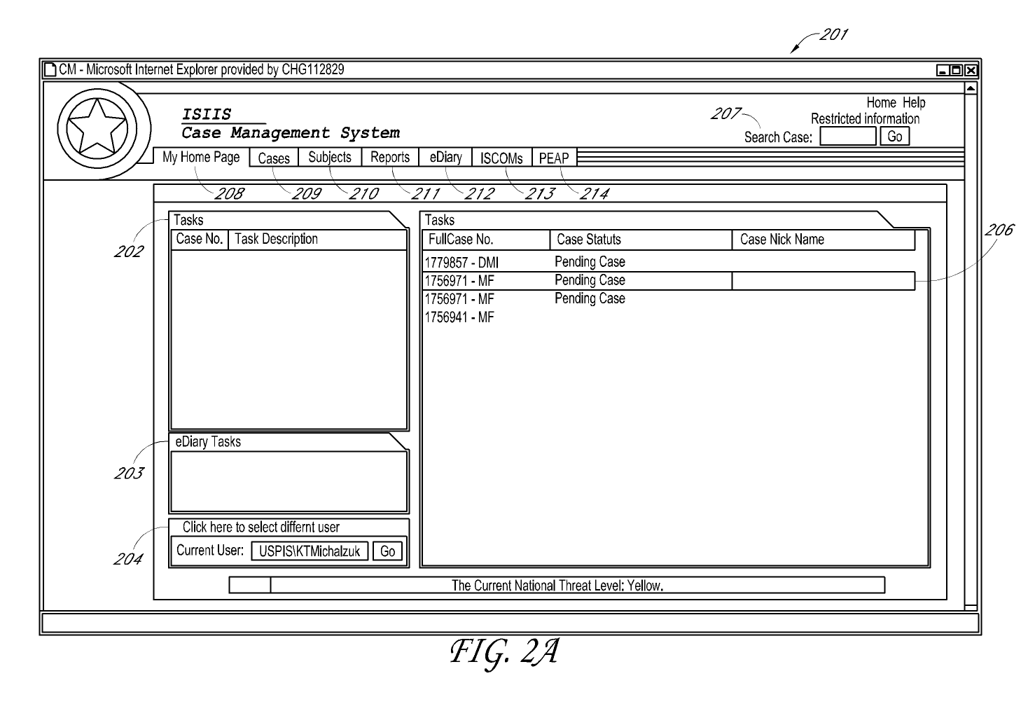

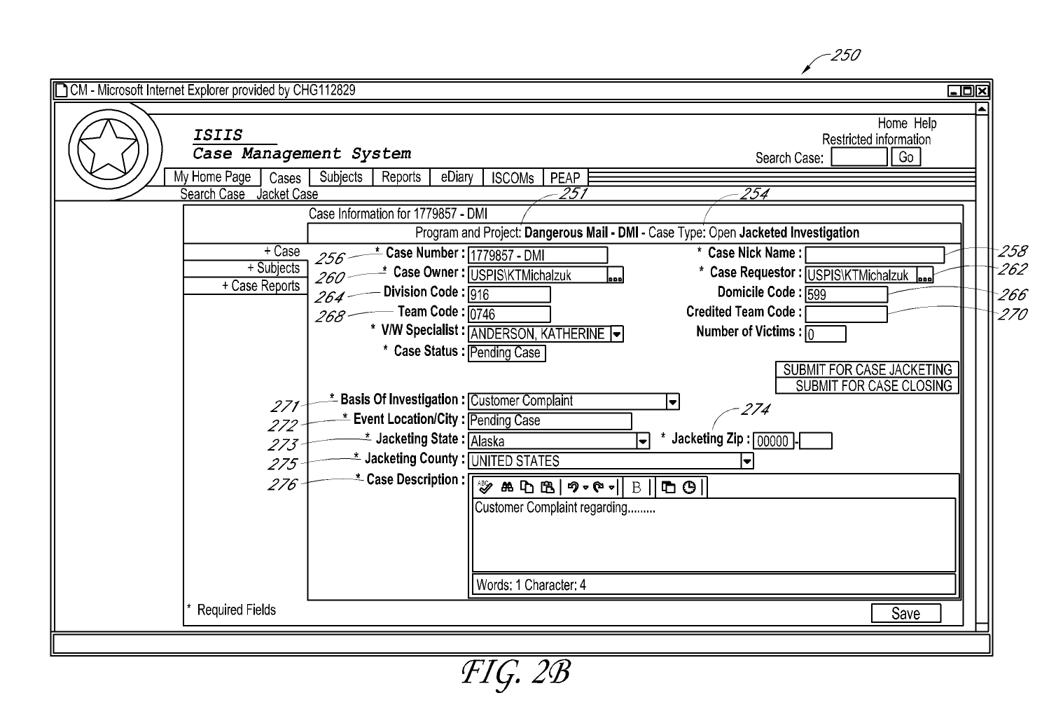

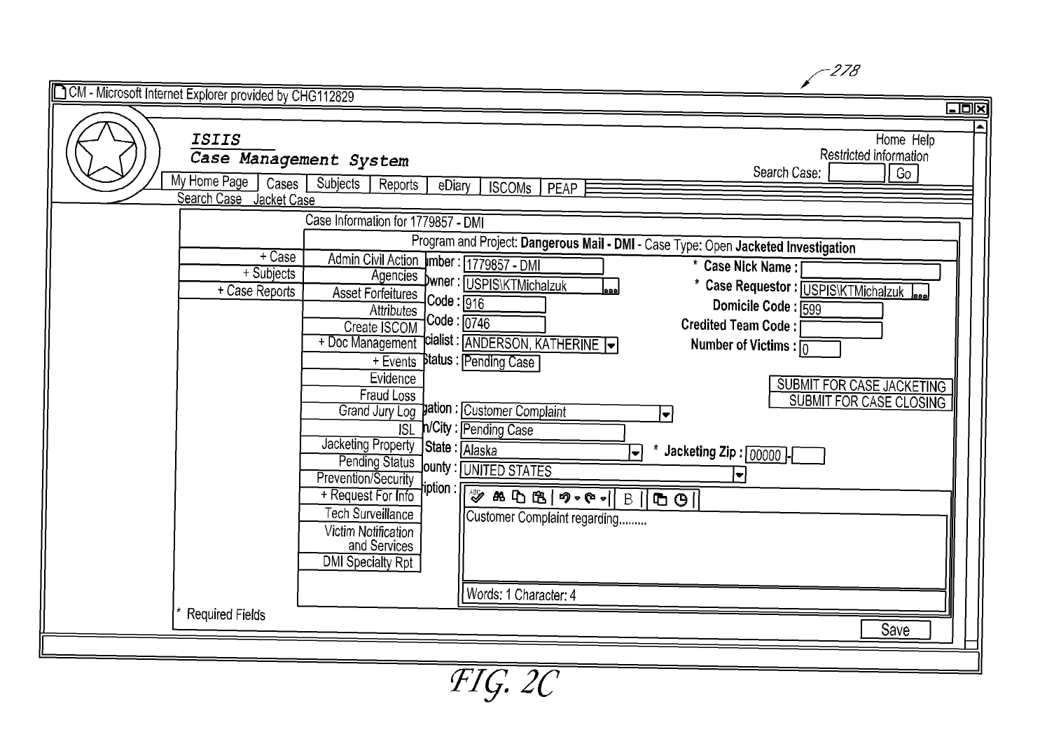

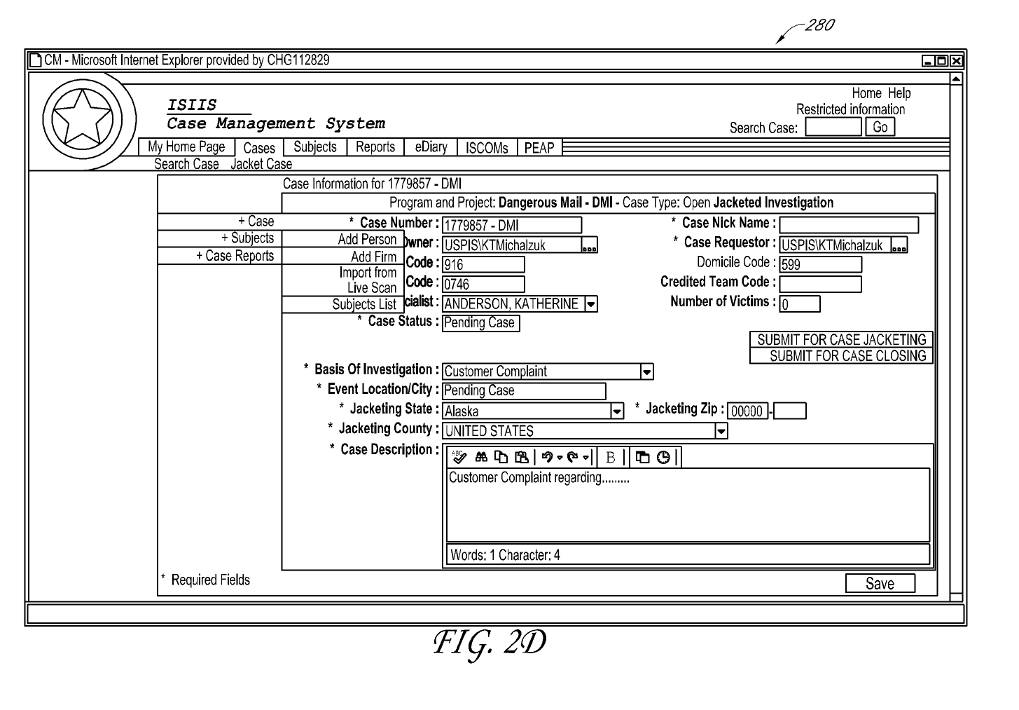

FIG. 2A illustrates a screen shot of an embodiment of the system 100 opening page, for instance, a Home Page. In this embodiment, after entering the CMS module 200, the opening page defaults to the user's Home Page 201. The Home Page 201 is comprised of tabs illustrating a Main Menu tabs section, the Tasks Window 202, a Diary Tasks Window 203, a Select Different User option 204, and a Cases Window 206 displaying the Full Case Number, the Case Status, and the Case Nick Name. The Home Page 201 also comprises a Search Case option 207. The Main Menu tabs comprise a My Home Page tab 208, a Cases tab 209, a Subjects tab 210, a Reports tab 211, a Diary tab 212, a Communications tab 213, and a PEAP tab 214. These tabs and options are used on the Home Page 201 to access various case management modules, as well as manage cases and associated tasks. In one embodiment, the menu choices are shown as tabs, as listed above and displayed across the top of the screen. In other embodiments, the menu choices are shown as buttons, a menu or drop down menus, or any other suitable display. Rolling the mouse pointer over any option, in one embodiment, will display a description of what the feature does.

The highest level tabs described above provide access to more specific or lower level related functions. For instance, the Main Menu Tabs as described above, provides access to CMS modules 200, namely, the My Home Page, Cases, Subjects, Reports, Diary, and Inspection Service Communications (ISCOMs) and PEAP tabs and are described below. The Tasks Window is located, in one embodiment, on the left side of the screen and provides certain pre-determined managers with delegated authority to manage and respond to case actions submitted for their approval. The Diary Task Window provides an interface such that pre-determined levels of managers or team leaders and persons with temporary delegated authority can review monthly summaries of case and other activity hours submitted for their approval. The Cases Window tab enables the case owner to manage his or her own case or work load. After a case is approved for closing, it no longer will display in the Cases Window. The Select Different User tab is populated by default based on the user's login ID. To select a user other than the logged in user, a list of other persons can be included in a directory tab and selected by the user. The Cases Search provides an interface for a user to search for a case or to create or jacket a new case. The Subjects tab is configured to search for the Investigative History File (IHF) of a person or firm connected to an existing organization's case or cases. The Reports tab provides an interface for a user to access or create pre-defined, pre-formatted and statistical reports. The Diary tab provides an interface for a user to enter case or other employee activity work hours and submit them each month for approval. The ISCOMs tab provides an interface for a user to view posted ISCOMs which can be sorted by, for instance, Office, Subject, Category, Date, Case ID, and From (the person who created the ISCOM). The Search Case tab can be utilized to access open and closed cases, including cases assigned to another inspector. The PEAP tab provides users the ability to track all evidence via a hand held or other portable scanning device from the point of collection to the disposition of the evidence.

Once a case number is entered, the display advances to the Case Information Screen as illustrated in FIG. 2B.

Moving to FIG. 2B, the Case Management System Screen 250 comprises a user display screen presenting pertinent case information about the selected particular case. In one embodiment, the following types of information are displayed: Program and Project (i.e. Fraud), Case Type 254 (i.e. Revenue Fraud), Case Number 256, Case Nick Name 258, Case Owner 260, Case Requestor 262, Division Code 264, Domicile Code 266, Team Code 268, Credited Team Code 270, Basis of Investigation 271, Event location/City 272, Jacketing State 273, Jacketing Zip 274, Jacketing Country 275 and Case Description 276 are just a few of the fields that may be displayed and that are displayed in the example FIG. 2B. Where appropriate, drop down boxes, menu, radio buttons or other formatting tools can assist the user with specifying certain options and criteria.

FIG. 2C illustrates the Cases Menu screen 278 displayed after the user selects “Case” from the left menu bar of the Case Management System Screen 250. The system 100 provides several categories and menus from which a user can choose. For instance, the system 100 includes an Administrative Civil Action tab, an Agencies tab, an Asset Forfeitures tab, an Attributes tab, a Case Info tab, a Create ISCOM tab, a Doc Management tab, an Events tab, an Evidence tab, a Fraud Loss tab, a Grand Jury Log, an ISL tab, a Jacketing Property tab, a Pending Status tab, and Prevention/Security tab, a Request for Info tab, a Tech Surveillance tab, and a Victim Notification and Services tab.

The Agencies tab is configured to provide a user interface to document law enforcement agencies, any authority of the federal, state, or local government and any company's security force, whose function is to investigate the commission of, or the attempted commission of, acts constituting a crime. The Asset Forfeiture tab is configured to accept from user input and display document details of assets involved in a criminal act that have been forfeited or seized. The Attributes tab is configured to accept user input and document the availability and or use of a particular investigative method or tool; a specific involvement; information obtained, for example, an admission, or loss. The Case Info tab will return the user to the main case record page created when the case file was originally jacketed. The Case Info page displays a number of items for instance, the case number, date of jacketing, cases status (open, closed, etc) the case owner, division, reason for jacketing case description and city or zip where the investigation takes place. The Document Management tab is configured to attach or append documents to the electronic case file. The Events tab is configured to accept user input and document actions that occur throughout an investigation. In addition to case and subject activities, events can also include updated investigative details, the completion of forms and credited or approved case actions. Events can also be transferred to another case through the use of Events or Transfer Events. For example, in this embodiment, the Create ISCOM menu is configured to provide reports indicative of case activities of a significant nature as outlined in guidelines defined by the system manager.

One embodiment includes an Inspection Service Log (ISL) menu which is configured to document investigative actions that at times result in subsequent activities being performed. Case ISL events are directly linked to the Diary 500 used to enter case and other activity hours. Once an ISL record is saved, a value of zero work hours will populate in the Diary 500. The CMS 200 provides an interface for users to modify these hours. The Pending Status menu provides an interface for users to document pending investigative actions. Actions that might cause a case to go into pending status include, for instance, Forfeiture Action, State Fugitive, Federal Fugitive, Appeal, Grievance to Arbitration, Grievance Other Committee, and Appeal rights. The Prevention and Security tab is provided in all jacketed cases. In one embodiment, the CMS 200 generates a user interface for users to report any prevention or security work associated with the specific jacketed case via the use of a system reporting tool. The Request for Information menu is provided to a user as an interface for requesting intelligence assistance for various products, for instance maps, chats and files, and track the history of each request. Once the request is completed, the analyst attaches the report or document to the respective case in the record. The Admin and Civil Action menu provides an interface for users to document administrative or civil actions and document penalties and assessments for project and program areas where action can be taken against a person or firm for a Civil False Claim (FCA/ACE and PFCRA). The Specialty Report menu gives users the option to produce reports which are electronic and are attached to a jacketed case to certain Projects as defined by the system administrator. The Evidence menu provides an interface for users to work with evidence, retrieve evidence from the scanner, transfer evidence, and set up a label printer. This is further explained the PEAP section.

FIG. 2D illustrates an embodiment of a Subject, Case Reports and Logs Screen 280. This screen 280 comprises display fields and user options such as Case Information, Case, Subjects, Case Reports. In FIG. 2D, the Cases tab is selected (highlighted), and the information shown is similar to the information show on the Case Information Screen 250. The Case, Subjects, and Case Reports tabs, shown in this embodiment on the left side of the display screen, make up the top level functions for this screen.

The Subjects option further contains the options to Add Person/Firm, Import from Live Scan and Subject List. The Add Person/Firm option provides an interface to add and relate a person or firm to a case. This can include suspects, victims, witnesses, claimants, etc. Any person or firm related to a case will display on the Case Related Subjects List. This list is also where the process of creating a person's/firm's Investigative History File (IHF) begins. From this location, it is also possible to remove a person from a case if no events have been added, change the case relations type, access the Subject Case Activity menu, edit Name and Address information if the Subject is not associated with more than one case, and view their existing IHF record if one exists. The Import from Live Scan provides an interface to obtain digital fingerprints of a subject taken in the Live Scan digital fingerprint system. The Subject List displays all case related subjects. The system 100 provides an interface for users to navigate to any specific subject record by clicking on the specific record. This Subject List is configured to originate the process or creation of a person's IHF. From this menu location, it is also possible to remove a person from a case if no events have been added, change his case relation type, access the Subject Case Activity menu, edit Name and Address information if the Subject is not associated with more than one case, and view the exiting IHF record if one exists. The Case Credited Events tab provides an interface to view all approved and credited events. The Case Summary Report provides an interface to review and or print a summary of the Case Request, Suspects, and Subjects, Credited Events, Investigative Details, etc. The Case Jacketing Report provides an interface to review and or print a summary of case jacket and activity information. The Investigative Expense Log provides an interface to view an expense log of investigative activities where cost was incurred. Report data is derived from information entered on the Expenses screen in the Diary 500 and business rules built into the system.

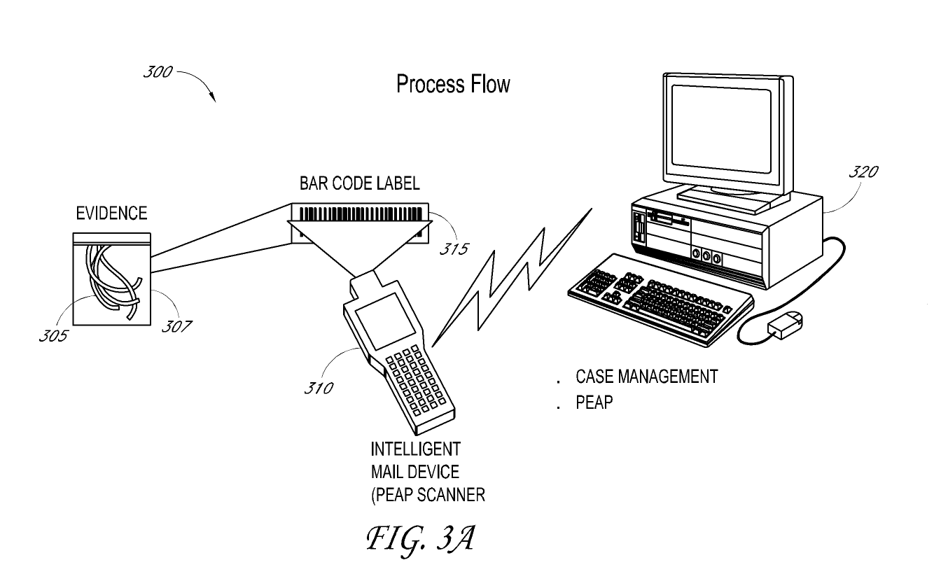

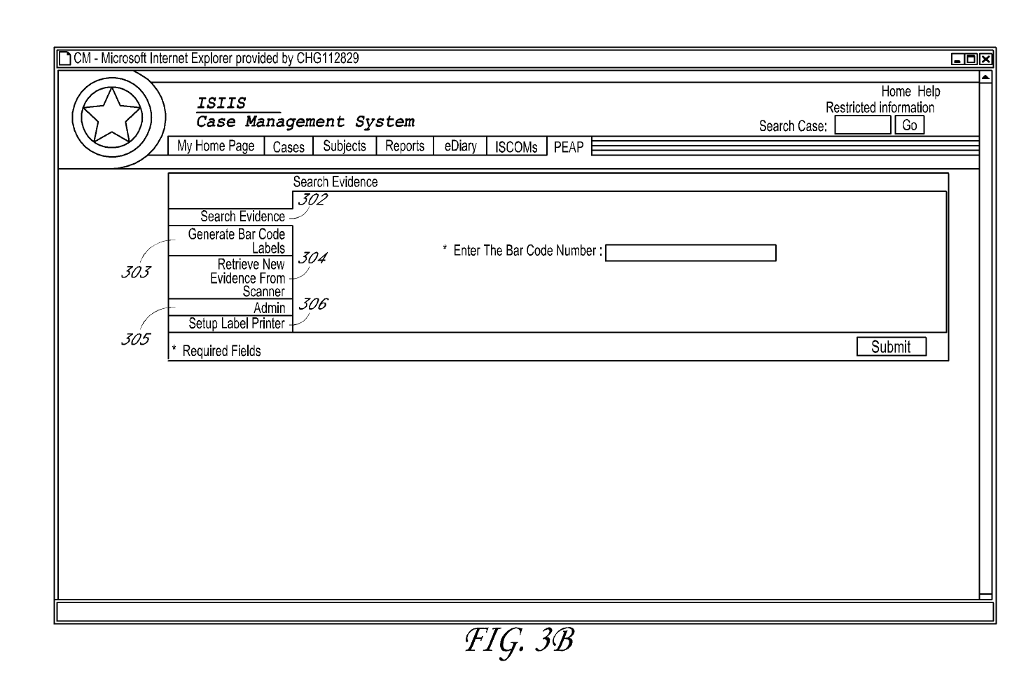

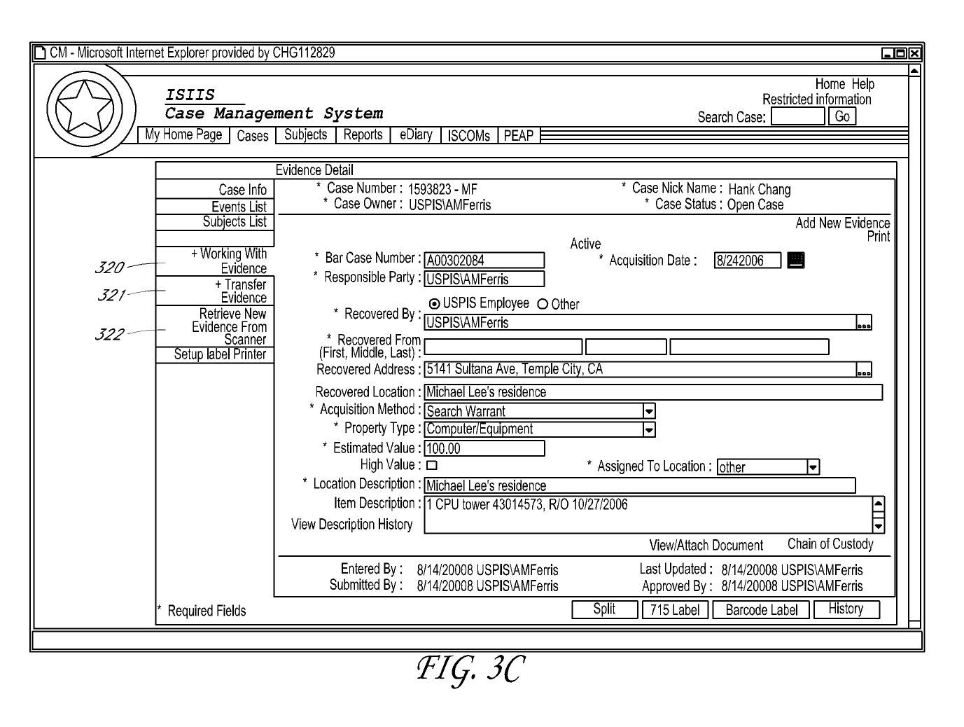

FIG. 3A further illustrates the process flow of the PEAP application 300, which includes the use of a sample of evidence 305, for instance hair, collected and stored in a plastic bag 307, the intelligent scanner 310, the barcode label 315 and the system host 320, for example, a computer system with a memory to store data and a processor to associate data with a case as well as to track and monitor the data, and to process data to run reports. The PEAP application is a streamlined electronic process for organizing and streamlining the evidence collection and tracing procedure. The manual process of handwriting evidence descriptions and evidence collection receipts as well as entering high value evidence is all processed electronically in the PEAP system 300. In the process, the evidence 305 is collected and stored in a plastic bag 307. A bar code label 315 associated with the evidence is produced by the scanner 310 and affixed to the plastic bag 307. The intelligent scanner 310 can accept and store additional investigator input of information indicative of the features of the evidence. This information is initially stored in the scanner 310. When the investigator returns to a location where the scanner can connect with the system 100 via a computer interface, the scanner 310 is docked and the information is uploaded to the system 100. The system 100 is configured to provide the investigator an interface to enter more information or details about the evidence including location data, details about the crime scene, possible related cases and any other related data.

In general, the PEAP system 300 uses preprinted barcode labels that are assigned to every piece of evidence as the basis of tracking evidence inventory and information. Each piece of evidence's preprinted barcode label is scanned by a mobile hand-held scanner at the crime scene. In one embodiment, all of the evidence collected at the crime scene is stored in the mobile hand-held scanner and then uploaded of the Case Management PEAP online system by docking the scanner to a network connected to a cradle at an organization's offices.

Once a piece of evidence's barcode label is uploaded in to the PEAP system 300, the system is configured to accept detailed information about the evidence by associating the barcode label's record. The PEAP system 300 uses a database to store all evidence barcodes, information, current inventory locations, chain of custody and responsible party history. Authorized personnel can use the PEAP system to track evidence in a more detailed manner than is done in the prior art.

### The Process of Using Bar Coding Evidence

In one embodiment, an evidence gatherer, e.g., a Postal Inspector, uses a pre-printed label or generates a label on-site via use of the portable wireless printer. An inspector places a bar code label on each item of evidence (high and low value) and/or seized property. The evidence gatherer scans the bar code label using the PEAP scanner and enters additional information into the scanner, such as description of the item, the location, and type of property. After all evidence and seized property has been labeled and data has been entered into the hand-held scanner, the evidence gatherer can use the scanner or another system component to generate a search warrant inventory receipt listing the items taken. The system 100 is configured to provide a new record in the CMS and uploads the data from the and-held scanner into the system 100. From the CMS, the system provides an interface for the evidence gatherer or another reviewer to manage the evidence using PEAP, or send the evidence to the a forensic laboratory using LIMS 400.

In one embodiment, the scanner of the PEAP Evidence Bar Coding application comprises a Motorola HC-700-L handheld scanner configured to scan and store the pre-printed barcode labels at the time of evidence collection. However, any suitable scanner will be appropriate. In this current embodiment, hand-held scanners may include scanners such as are commonly by the U.S. Postal Service for scanning mail pieces including, for instance, intelligent mail devices. In one such embodiment, the scanners are reprogrammed for use by the organization, and may be configured to run a desktop user interface such as a version of MS Windows to provide a conventional point and click and drag and drop functionality as provided by a desktop computer.

In one embodiment, bar code labels to be attached to evidence are produced using a special portable printer, the scanner then scans the bar code to capture its data in association with data entered by a user to identify the evidence/property item, and the barcode data and associated data uploaded into PEAP 300. The system 100 may be configured to accept edits and/ or deletions of an evidence record using the handheld scanner prior to uploading the data into the system.

### Integration of the PEAP Scanner Into Case Management

FIG. 3B illustrates an embodiment of a PEAP Case Management page in the system 100, which can be, as in this embodiment, accessed from the Home Page 201 of the system 100. Once selected, users have the ability to Search Evidence, Generate Bar Code Labels, Retrieve New Evidence from Scanner, Administrative Functions, Set Up Label Printer, and Destruction of Evidence.

The Search Evidence function 302 locates bar codes associated with evidence items. The Generate Bar Code Labels function 303 produces printer labels from the label printer. The Retrieve New Evidence From Scanner function 304 associates bar code data uploaded from a scanner to an active case. The Administrative function 305 identifies the Evidence Control Officers in the user's division. The Setup Label Printer 306 locates and sets up the label printer on the user's network. The Destruction function identifies evidence marked for disposal or that has been destroyed.

However, once a user is in a specific open case, the system 100 is configured to provide the user an interface to select the evidence tab from the dropdown menu. This will give users the ability to work with evidence, transfer evidence retrieve evidence from the scanner and set up the label printer.

When the Working with Evidence option 320 is chosen, as illustrated in FIG. 3C, the system 100 provides an interface for either searching for evidence within the case or in any case with which the evidence may be associated or else listing all evidence currently attached to the specific case currently logged into. The system 100 is also configured to display an input screen that prompts the user to add new evidence items to the system. In this embodiment, the Working with Evidence screen displays for the user the Case Number, Case Nick Name, Case Owner, Case Status, evidence Bar Code Number, Acquisition Date, Responsible Party, Recovered by, Recovered From, Recovered Address, Acquisition Method, Property Type, Estimated Value, Assigned to Another Location, Location Description, and Item Description.

One feature is the Transfer of Evidence option 321 for which the system 100 provides an interface to track the electronic case file within the system 100, making it possible to track the history of all transferred evidence within case management. When the Transfer Evidence option is selected, the system 100 is configured to provide a choice of options including Transfer Evidence to a Different Case, Different Inspector, Other Agency, Final Disposition and log as Returned Evidence from Other Agency. Each choice above would result in a different user interface on the user's computer. In one embodiment, all transfers require an approval process.

In one embodiment, for example with USPIS employees, the approval process is electronic whereby the person receiving the evidence goes into the system 100 and clicks ‘Accept’ for each piece of evidence transferred to him. Evidence might be transferred or sent to an outside agency. In this case, for outside agencies, the form including the barcode is printed and the receiving person signs and dates the form.

When the “Retrieve New Evidence from Scanner,” 322 also an option along the left side in FIG. 3C, is selected, the system 100 is configured to provide options for uploading evidence stored in the handheld scanner or other similar portable device into the system 100. Once the scanner is placed into the docking station, the system 100 detects the device and provides an interface to proceed with a data transfer. A list of all evidence from the scanner appears on the user's screen. The system 100 is further configured to provide an interface to for selecting each piece of evidence for association with a specific case and then an interface for confirming the “Add to Case” Option. The evidence is transferred from the scanning device into the specific case in the system 100. In another embodiment, the scanner communicates with the host computer via RF or wireless connections. In yet other embodiments, the scanner has a removable memory which can be plugged into another computer. In one embodiment, this process is encrypted using encryption software or it is password protected. In other embodiments the system 100 may erase the information from the scanner's memory once it is added to the system.

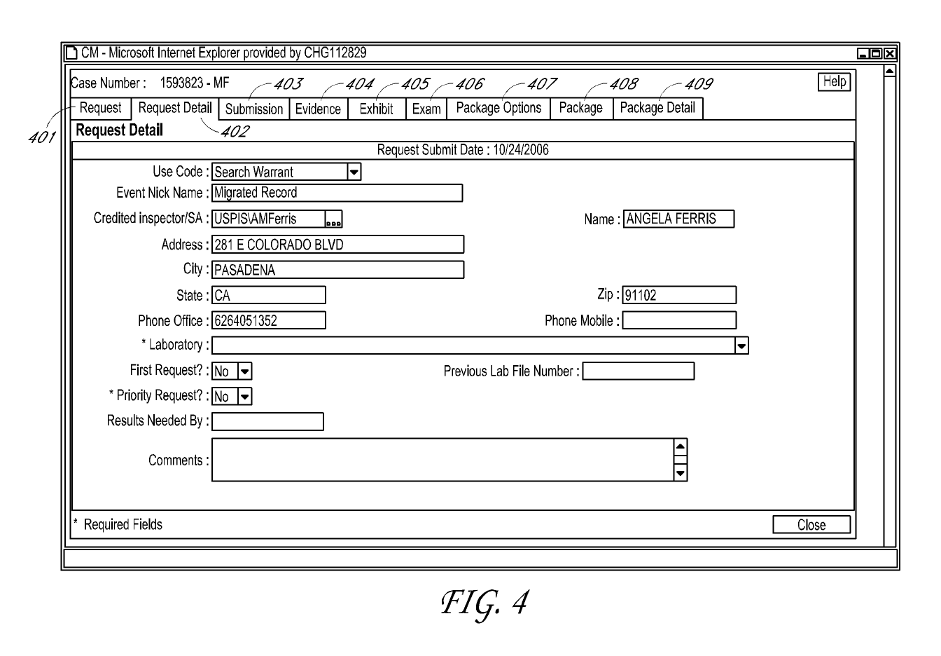

FIG. 4 is a screen shot of the LIMS interface 400. The main screen displays the LIMS features available to the user, in this embodiment comprising Request 401, Request Detail 402, Submission 403, Evidence 404, Exhibit 405, Exam 406, Package Options 407, Package 408, and Package Detail 409 tabs. In this embodiment, all evidence going to an organization's lab (e.g. the USPIS lab) is submitted using the system 100 LIMS 400 application. The LIMS interface 400 is configured to provide a user-interface to submit evidence to the lab, and must be completed for a successful submission of a lab request. The Request Detail process is further explained below. The LIMS interface 400 comprises a display which prompts a user to input information including Use Code, Event Nick Name, Credited Inspector, Name, Address, City, State, Zip, Office Phone, Mobile Phone, Laboratory, First Request?, Priority Request?, Results Needed By, and Comments. In other embodiments other or few fields may be required.

In one embodiment, the system 100 is configured to provide the user an interface to open a case in the CMS 100 and then select Evidence in the submenu. When a user selects a sequence of Transfer Evidence (along the gray vertical menu bar) followed by Request Crime Lab Analysis (in the submenu), the system 100 is configured to display the LIMS REQUEST page in a new window, beginning at the request tab. At this point, the system 100 is configured to accept a request to Add New Request by the user. The Request Detail tab appears in the LIMS Request page (as illustrated in FIG. 4). If the request is high priority, the Yes option should be chosen and the Priority Reason field appears on the screen. When the remaining fields are complete the system 100 is configured to save the information and complete the user's request when the Submission tab is selected followed by the Package options tab. Once the page is mailed or hand delivered, the Lab personnel uses the scanner to “Accept” the transfer of evidence to the Lab. Once the Lab analysis is completed, the final results are submitted into the system 100 where the results become electronically part of the case. The Lab may package the evidence and mail it back to the case agent. The case agent receives the package, scans the evidence contents and accepts the transfer-back from the lab.

In this embodiment, prior to a case closing, all evidence must be disposed of In this embodiment, when a tab sequence Evidence—Transfer Evidence—Final Disposition is chosen, the system 100 provides an interface to identify the specific evidence within the case that is selected for disposal. For each piece of evidence, the user chooses from a list of pre-determined and approved choices, for instance, “return to rightful owner”, “forfeiture specialist”, “send to court and/or prosecutor”, “destroyed”, “organization internal lab/destruction”, “send to anther agency or organization”, “mail recover”, “custodian”, “case file” or other appropriate dispositions.

Depending on the choice selected from above and the type of evidence, various levels of approval will be necessary. For instance, in some cases, up to two witnesses should be present at the time of designating evidence for destruction, while for others, no witnesses are necessary. In one embodiment, all of the business rules pertaining to witnesses and approval for disposition are built into the system 100 and PEAP system based on the organization's rules and regulation pertaining to evidence.

Those of skill in the art will recognize that the various illustrative logical blocks, modules, circuits, and algorithm steps described in connection with the embodiments disclosed herein may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in another embodiment, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In another embodiment, the storage medium may be integral to the processor. The processor and the storage medium may reside in an ASIC.

While the above detailed description has shown, described, and pointed out novel features as applied to various embodiments, it will be understood that various omissions, substitutions, and changes in the form and details of the device or process illustrated may be made by those skilled in the art without departing from the spirit of the invention. As will be recognized, the embodiments may include forms that do not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

What is claimed is:

1. An electronic laboratory crime lab management system, the system comprising:
a memory configured to store data associated with laboratory requests and data indicative of utilization of laboratory resources; and
a processor configured to:
receive at least one electronic request for a laboratory examination of an item submitted to a lab,
store data indicative of the at least one received request to the memory;
receive actions associated with processing the at least one laboratory request; and
track and store information indicative of laboratory work performed on and associated with the item submitted to the crime lab starting with the request and continuing through an investigation and closure of the case, based on the received processing actions.

2. The system of claim 1, wherein the system is further configured to generate report using data associated with the laboratory request.

3. The system of claim 1, wherein the system is further configured to generate a report demonstrating the chain of custody based on the stored data.

4. An automated system for electronic management and tracking of evidence, for use in a computing environment having a processor and a data storage, the evidence system comprising:
a memory configured to:
store at least evidence collection data and evidence tracking profiles;
store data associating the evidence collection data with a scene of an investigation; and
at least one processor configured to:
detect a data connection with a mobile scanner configured to scan data indicative of evidence at the scene of an investigation;
receive information from the mobile scanner;
receive data indicative of the assignment of the evidence and its associated information to an investigation;
track evidence inventory and information via data received for each item of evidence or evidence packaging.

5. The system of claim 4, wherein the data received for each item is received via scanning a bar code affixed to the evidence or evidence packaging.

6. The system of claim 4, wherein the received data indicative of the assignment of the evidence and its associated information to an investigation is based on data received via user interface.

7. The system of claim 4, wherein the received data indicative of the assignment of the evidence and its associated information to an investigation is based on data received via mobile scanner.

8. The system of claim 4, wherein the received data indicative of the assignment of evidence to an investigation is based on geo-coded information obtained at the crime scene that includes the global positioning system (GPS) coordinates of the evidence scanned at the scene of the investigation.

9. An automated inspection service information system for use in a computing environment having a processor and a data storage, the system comprising:
a memory configured to store data indicative of employee and user profiles, store activities indicative of an investigation, and store available resources for a specific task assignment; and
at least one processor configured to:
electronically process and track evidence;
monitor activities associated with criminal investigations;
provide electronic requests for laboratory examination to a crime lab,
manage and monitor data indicative of a crime investigation wherein the data is associated with employee training and employee skills, applications for detail assignments, results of employee searches, and reviewed employee objectives; and
monitor available resources for a specific task assignment and determine where the resources within that task assignment should be located;
wherein the system provides, based on the information stored in a memory and processed by the system, the data indicative of the resources for assignment to certain investigations.

10. The system of claim 9, wherein the memory further comprises a database.

11. The system of claim 9, further comprising more than one integrated databases.

12. The system of claim 9, wherein the system is further automated to assist with the collection, verification and validation of the results of investigative, security and preventative efforts to support the mission of the US Postal Service.

13. The system of claim 9, further comprising entering and submitting activities and hours being charged against a case, as well as time associated with other employee activities including leave administrative time, and training.

14. The system of claim 13, wherein the at least one processor is further configured to store to memory received data indicative actual time spent on specific cases or other activities is entered, submitted, tracked and retrieved by all users as needed.

15. The system of claim 13, further wherein the at least one processor is further configured to determine the amount of resources a specific job assignment should have and where the resources within that job assignment should be located.

16. The system of claim 9, wherein the processor is configured to report data indicative of monitoring and tracking laboratory requests, lab work requested, and lab personnel assigned to specific tasks.

17. The system of claim 9, further comprising a preprinted barcode label that is assigned to every piece of evidence as the basis for tracking evidence inventory and information.

18. The system of claim 17, wherein the barcode on each piece of evidence is scanned by a mobile hand-held scanner at the investigation scene.

19. The system of claim 9, further comprising a security clearance tracking system, a complement module, a health assessment module, and reporting capabilities.

20. The system of claim 9, further comprising managing profiles, tracking training and other skills, applying for detail assignments, conducting employee searches, and completing the reviewed objectives, mid year and year end pay for performance steps for insurance.

21. A method for tracking evidence, the method comprising:
receiving into a server, via an electronic reader device, data indicative of an identifier relating to a piece of evidence;
storing the data to a database;
associating the identifier with case;
maintaining a database having entries indicative of processing steps associated with the item of evidence;
providing system users the ability to electronically manage resources and track data related to a case; and
querying a database having records indicative of actions associated with the database; and
displaying data indicative of at least one record of the database.

22. The method of claim 21, further comprising a method of protecting data.

23. The method of claim 22, wherein the protection is achieved by at least two of controlling access, logon actions and reporting exemptions.

24. The method of claim 21, wherein receiving the identifier comprises receiving data indicative of a bar code associated with the item of evidence.
